(19) United States
(12) Patent Application Publication
(10) Pub. No.: US 2010/0038294 A1
(43) Pub. Date: Feb. 18, 2010

(54) CENTRIFUGAL SEPARATION APPARATUS

(76) Inventors: Charles Dugan, Cottage Hills, IL (US); Cornelius F.H. Van Egmond, Canyon Lake, TX (US)

Correspondence Address: POLSINELLI SHALTON FLANIGAN SUELTHAUS PC, Suite 1100, 100 South Fourth Street, St. Louis, MO, 63102-1825, US

(21) Appl. No.: 12/190,410

(22) Filed: Aug. 12, 2008

(51) Int. Cl. B01D 21/26; B01D 21/30

(52) U.S. Cl. 210/144; 210/225

(57) ABSTRACT

A centrifugal separating apparatus having a vessel with a chamber assembly disposed therein that is rotated by a rotatable main shaft driven by a motor at a predetermined speed for separating water and oil from a stream of fluid. The rotatable chamber assembly defines an upper chamber for receiving the stream of fluid from an inlet tube and a lower chamber for collecting water separated from the stream of fluid. The upper chamber is in fluid flow communication with a plurality of U-tube assemblies with each assembly having a pair of upper oil separation tubes and a single lower water separation tube that extends outwardly in a radial direction from the chamber assembly at the near end of each U-tube assembly. The free end of each U-tube assembly is engaged and communicates with one of a plurality of tubular return sections that collectively define an outer tube that allows for the separation of the oil and water from the stream of fluid during rotation of the main shaft by the centrifugal separating apparatus. A strain retaining plate is engaged to the chamber assembly and the outer tube for providing structural support such that centripetal forces applied by rotation of the main shaft does not apply excess stress to the U-tube assemblies. The motor is in operative association with a microprocessor controller that terminates operation of the apparatus when vibrations generated by the operation of the apparatus exceeds a predetermined value.

### FIELD

This document relates to a centrifugal separation apparatus, and more particularly to a centrifugal separation apparatus for separating fluids having different specific gravities.

### BACKGROUND

Many oil wells may produce an effluent containing oil, water and gas components. For many years, the fluids and other well effluent produced from a well have been passed through dewatering tanks to separate the gas, oil and water components of the effluent. Such tanks are typically provided with baffles and compartments through which the well effluent is passed. Oil with a typical density of 0.75 to 0.85 being lighter than water with a density of 1.0, is expected to rise to the top of the effluent and be drawn off from a compartment to which the upper part of the effluent is permitted to pass, while the denser water may be drawn off from the bottom portion of the tank.

Centrifugal separation apparatuses for performing oil and water separation by centripetal force are known in the art. In particular, a centrifugal separation apparatus may include a stationary housing in which is centrally disposed for rotation therein a central chamber assembly. The central chamber assembly may include an upper chamber adapted to separate oil from the effluent and a lower chamber for the storage of water separated from the effluent. In one embodiment, the centrifugal separation apparatus may include plurality of U-tube assemblies that extend outwardly in a radial direction from the central chamber assembly that communicate through one of a plurality of tubular return sections that collectively define an outer tube that surrounds the central chamber assembly. A motive force is provided that rotates the central chamber assembly and the U-tube assemblies about a central vertical axis that applies an artificial gravity to the effluent entering the centrifugal separation apparatus in order to separate the oil and water components of the effluent by use of centripetal force. This centripetal force can apply a great amount of stress to the U-tube assemblies, especially along the joints where each U-tube assembly engages the central chamber assembly.

As noted above, operation of the centrifugal separation apparatus rotates the central chamber assembly at a fast rate of speed to generate the artificial gravity necessary to separate liquids having different specific gravities. As such, the centripetal force applied to the effluent that enters the central chamber assembly will begin to separate the lighter oil from the heavier water; however, if the amount of effluent and its component water or oil in the U-tube assemblies or the outer tube is not spread generally even among these components, the rotational forces generated by the centrifugal separation apparatus can cause the apparatus to excessively vibrate due to the unbalanced load of the effluent and its components. In some instances, this unbalanced state of the effluent and the excessive vibrations imparted to the structural elements of the centrifugal separation apparatus can cause the catastrophic failure of the apparatus as the U-tube assemblies and outer tube break apart.

As such, there is a need in the art for a centrifugal separation apparatus that prevents centripetal forces applied to the U-tube assemblies and related components from applying excessive force to the U-tube assemblies. There is also a need in the art for a mechanism that prevents the catastrophic failure of the centrifugal separation apparatus due to an unbalanced load of effluent in the apparatus that may cause the apparatus to excessively vibrate.

### SUMMARY

In an embodiment, a centrifugal separation apparatus is provided for separating oil and water from a stream of fluid whose components include oil and water. The apparatus may include a hollow vessel having an inlet tube through which the stream of fluid may enter the vessel. A rotatable chamber assembly is centrally disposed in the vessel for rotation about a vertical axis wherein the rotatable chamber assembly includes an upper chamber and a lower chamber for the collection of separated oil. The upper chamber is in fluid communication with the inlet tube to receive the stream of fluid therefrom and one or more nipples that extend a predetermined distance into the upper chamber for collecting oil separated from the stream of fluid. In addition, the apparatus may further include one or more U-tube assemblies that extend outwardly from the rotatable chamber assembly in a radial direction with each U-tube assembly having at least one upper tube and at least one lower tube in fluid flow communication with a connecting outer tube.

A strain retaining plate may be engaged to the outer tube and said chamber assembly for providing structural support to the plurality of U-tube assemblies. A rotatable main shaft is in operative engagement with the rotatable chamber assembly for rotating the chamber assembly about the vertical axis at a predetermined speed in which the stream of fluid entering the upper chamber is subjected to centripetal forces which in combination with gravitational forces cause oil and water in the stream of fluid to separate into different components. During operation of the apparatus, the separated water passes through at least one upper tube, the connecting outer tube, and at least one lower tube for collection in the lower chamber such that water may exit through a water outlet tube in communication with the lower chamber. Simultaneously, the separated oil may flow through the upper tubes to the outer tube and back the upper tube such that the separated oil exits the upper chamber through one or more of the nipples.

In another embodiment, a centrifugal separation apparatus for separation oil and water from a stream of fluid whose components include oil and water may include a hollow vessel having an inlet tube through which the stream of fluid may enter the vessel. A rotatable chamber assembly is centrally disposed in the vessel for rotation about a vertical axis with the chamber assembly defining an upper chamber in communication with the inlet tube for receiving the stream of fluid and a lower chamber for the storage of water separated from the stream of fluid. The centrifugal separation apparatus may further include one or more U-tube assemblies with each of the one or more U-tube assemblies having a proximal end that extends outwardly in a radial direction from the chamber assembly and a distal end that is engaged and in communication with an outer tube. A main shaft is operatively engaged to the rotatable chamber assembly for rotating the chamber assembly at a predetermined speed about the vertical axis in which the stream of fluid entering the chamber assembly is subjected to centripetal which in combination with gravitational forces cause oil and water in the stream of fluid to separate. Finally, a strain retaining plate is engaged to the outer tube and the chamber assembly for providing structural support to the one or more U-tube assemblies.

In yet another embodiment, a centrifugal separation apparatus for separating oil and water from a stream of fluid whose components include oil and water may include a hollow vessel having an inlet tube through which the stream of fluid may enter the vessel. A rotatable chamber assembly is centrally disposed in the vessel for rotation about a vertical axis with the chamber assembly defining an upper chamber in communication with the inlet tube for receiving the stream of fluid and a lower chamber for the storage of water separated from the stream of fluid. The centrifugal separation apparatus may include one or more U-tube assemblies with each of the one or more U-tube assemblies having a proximal end that extends outwardly in a radial direction from the chamber assembly and a distal end that is engaged and in communication with an outer tube. A main shaft is operatively engaged to the rotatable chamber assembly for rotating the chamber assembly at a predetermined speed about the vertical axis in which the stream of fluid entering the chamber assembly is subjected to centripetal forces which in combination with gravitational forces cause oil and water in the stream of fluid to separate. A motor is in operative engagement with the main shaft for rotating the chamber assembly with the motor being in operative association with a microprocessor controller for controlling the operation of the motor. Finally, the centrifugal separation apparatus may include a means for detecting the degree of vibrations generated by the apparatus with the means for detecting the degree of vibrations generated by the apparatus being in operative association with the microprocessor controller for terminating the operation of the centrifugal separation apparatus when the degree of vibrations exceeds a predetermined value.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a simplified block diagram of the centrifugal separation apparatus illustrating the separation of effluent into heavy and lighter liquids;

FIG. 2 is a simplified partial cross-sectional illustration of the centrifugal separation apparatus showing the U-tube assemblies;

FIG. 3 is another simplified partial cross-sectional illustration of the centrifugal separation apparatus showing the oil and water outlet tubes;

FIG. 4 is top view of the centrifugal separation apparatus showing the U-tube assemblies, oil and water outlet tubes, and outer tube;

FIG. 5 is a top view of the strain retaining plate engaged to the outer tube;

FIGS. 6-9 are schematic representations of U-tube assembly arrangements for illustrating the principle of operation of the centrifugal separation apparatus;

FIG. 10 is a perspective view of the nipple illustrating the flow of lighter liquid from the upper chamber of the centrifugal separation apparatus;

FIG. 11 is a top view of the distribution cone illustrating the flow of effluent into the upper chamber of the centrifugal separation apparatus; and

FIG. 12 is a partial perspective view illustrating the U-tube assembly arrangement with the outer tube and chamber assembly of the centrifugal separation apparatus.

Corresponding reference characters indicate corresponding elements among the view of the drawings. The headings used in the figures should not be interpreted to limit the scope of the claims.

### DETAILED DESCRIPTION

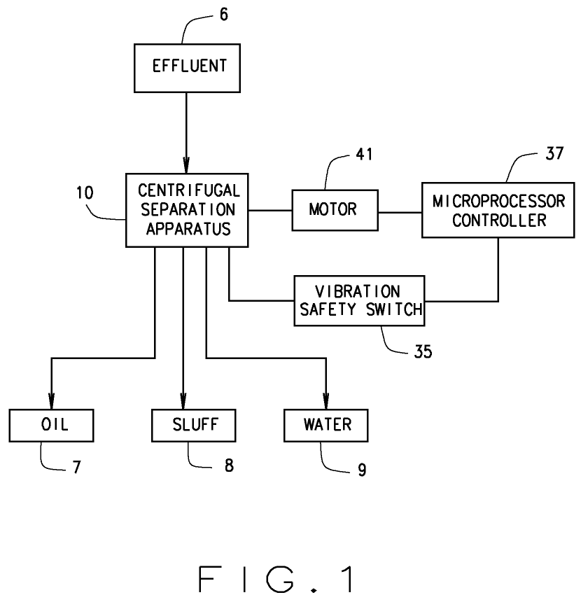

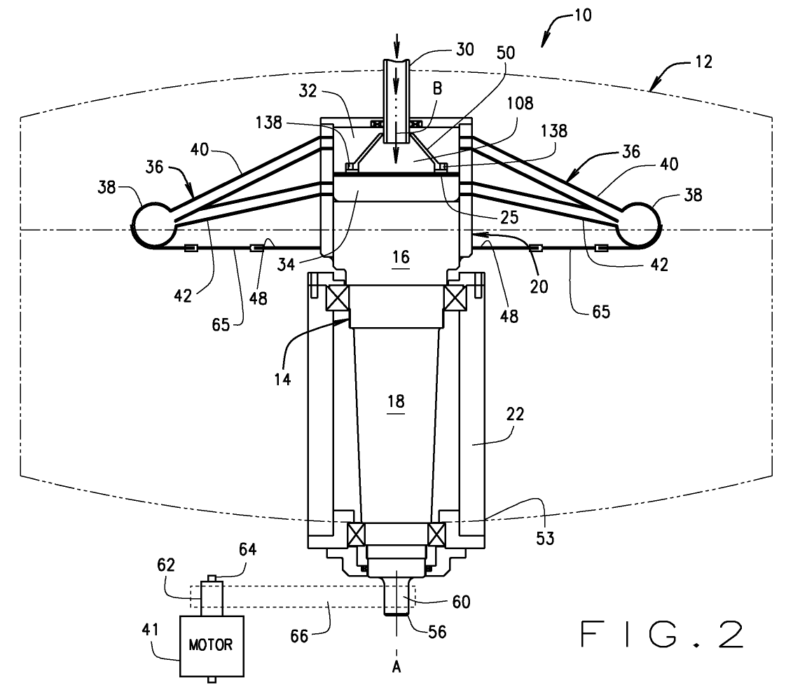

Referring to the drawings, an embodiment of the centrifugal separation apparatus is illustrated and generally indicated as 10 in FIG. 1. As shown, the centrifugal separation apparatus 10 allows for the separation of oil 7 and water 9 contained in a stream of fluid, such as an effluent 6. Referring to FIG. 2, the centrifugal apparatus 10 includes a vessel 12 that houses a chamber assembly 20 operatively engaged to a rotatable main shaft 14 that rotates about a vertical axis A such that the lighter oil 7 is separated from the heavier water 9 component of the effluent 6 which is then collected in separate compartments within the vessel 12.

The rotatable main shaft 14 defines an upper shaft portion 16 that rotates the chamber assembly 20 and a lower shaft portion 18 that freely rotates within a cartridge 22 that surrounds the lower shaft portion 18 and extends through a central opening 53 defined in the lower end of vessel 12 for operative engagement with a motor 41. The part of the lower shaft portion 18 below the vessel 12 defines a distal portion 56 having a shaft pulley 60 that is operatively engaged to a motor pulley 62 of motor 41 by a belt 66 (shown in phantom). The motor 41 includes a motor shaft 64 that drives the motor pulley 62 when the motor 41 is made operational such that the belt 66 rotates the main shaft 14. As such, rotation of the main shaft 14 concurrently rotates the chamber assembly 20 in order to generate centripetal forces that will separate the oil 7 and water 9 from the effluent 6. As shown in FIG. 1, the motor 41 is operatively associated with a microprocessor controller 37 that controls the operation of the centrifugal separation apparatus 10.

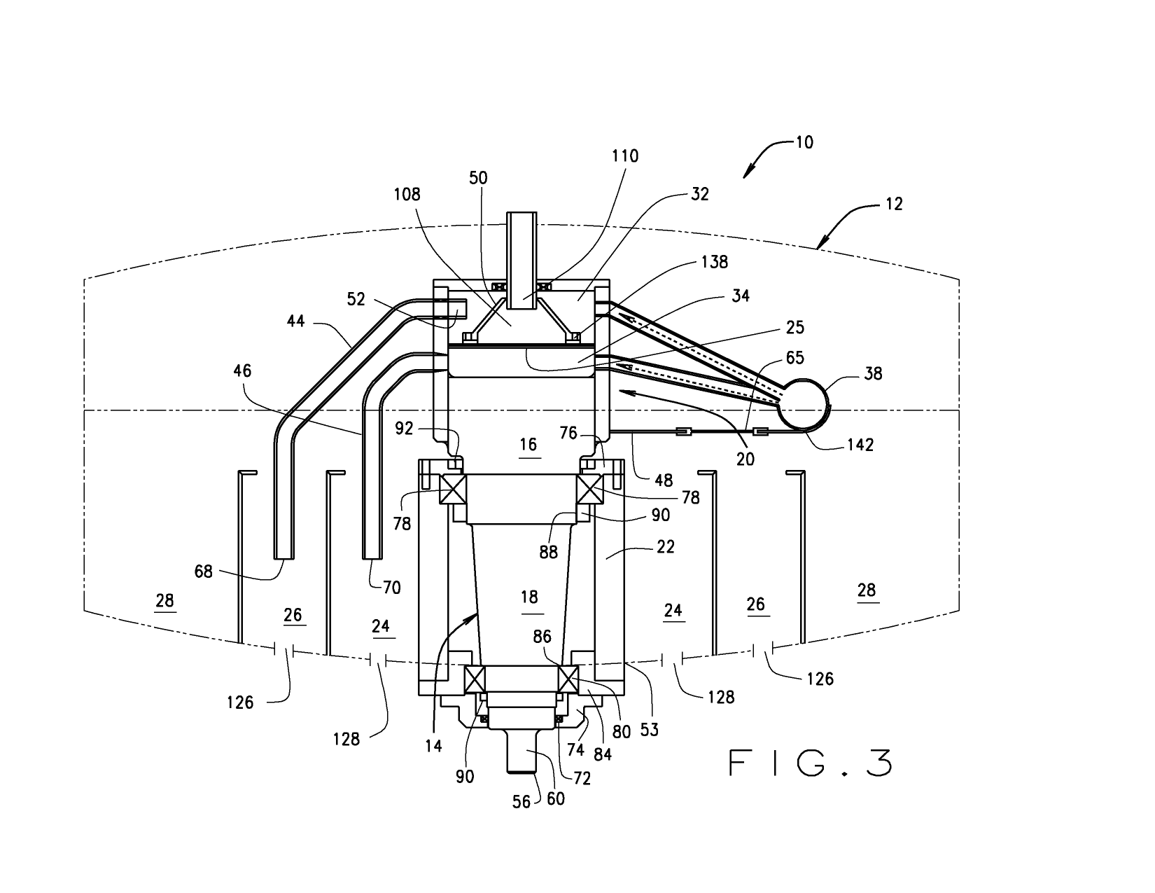

Referring to FIG. 3, the cartridge 22 includes various structural sealing, bearing and retaining components that support and seal off the lower shaft portion 18 of main shaft 14 along the upper and lower parts of the cartridge 22. A bear retaining nut 90 surrounds the lower shaft portion 18 along the lower part of the cartridge 22 and is retained in place by a lip seal retainer 74 having a lip seal 72 that provides a fluid tight seal with the main shaft 14. The lip seal retainer 74 abuts a lower bearing cartridge 84 and contacts a lower bearing 80 that surrounds the lower shaft portion 18. The lower bearing 80 also abuts a shoulder 86 defined by the lower shaft portion 18. In addition, the upper part of the cartridge 22 that communicates with the lower shaft portion 18 of main shaft 14 includes an upper bearing 78 that contacts an upper retainer and seal holder arrangement 76 and is retained by a bearing retaining nut 90 that is engaged to a threaded portion 88 defined along a part of the lower shaft portion 18. As shown, the upper retainer and seal holder arrangement 76 also contacts a lip seal 92.

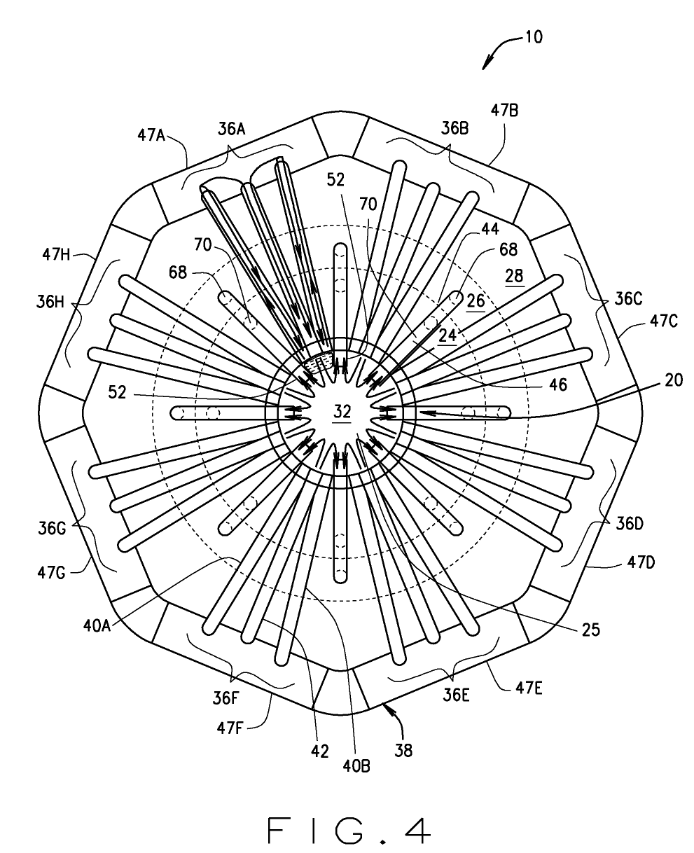

Referring to FIGS. 2 and 3, the chamber assembly 20 includes an upper chamber 32 for the separating the heavier water 7 from the lighter oil 9, and a lower chamber 34 that stores the water 7 separated from the oil 9 of effluent 6 during the centrifugal separation process. A separator plate 25 is interposed between and physically divides the upper chamber 32 and lower chamber 34. Referring to FIGS. 3 and 4, a plurality of water outlet tubes 46 communicates with the lower chamber 34 for transporting separated water 7 from the lower chamber 34 of the chamber assembly 20 to an inner compartment 24, while a plurality of oil outlet tubes 44 communicates with the upper chamber 32 for transporting separated oil 9 from the upper chamber 32 to an intermediate compartment 26 as shall be discussed in greater detail below.

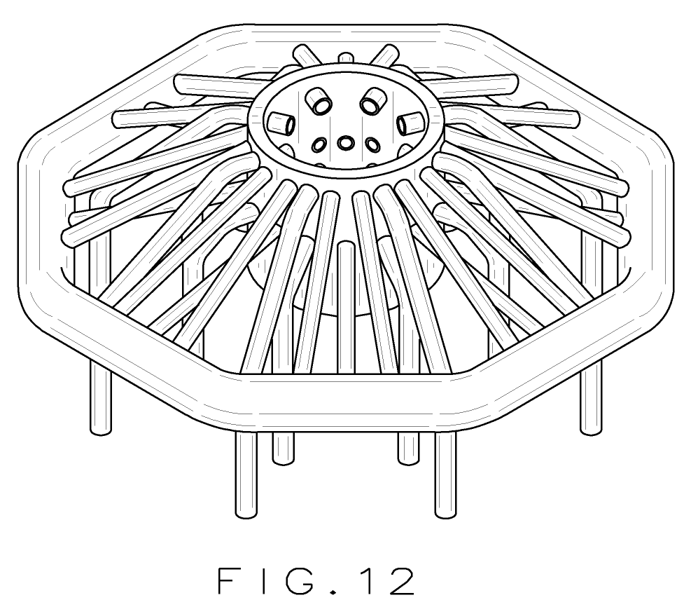

As shown in FIGS. 2 and 11, the upper chamber 32 of the chamber assembly 20 includes a distribution cone 50 disposed therein that provides a means for initially distributing the effluent 6 within the upper chamber 32 as the effluent 6 enters the centrifugal separation apparatus 10 through inlet tube 30. The distribution cone 50 may have a generally frusto-conical shaped body 69 that defines an interior area 108 that communicates with an upper central aperture 136 for receiving effluent 6 from the inlet tube 30 at one end of the distribution cone 50 and a flanged edge 138 defined at the other end thereof. A plurality of angular spaced supports 94 (shown in phantom) are affixed to the bottom of the flanged edge 138 to support the distribution cone 50 in order to slightly elevate the distribution cone 50 relative to the separation plate 25 and to provide radial paths through which the effluent 6 entering the upper chamber 32 must pass prior to egress from the upper chamber 32.

As further shown in FIGS. 2, 4 and 12, a plurality of U-tube assemblies 36 extend outwardly in a radial direction from the chamber assembly 20 and are in communication with one of a plurality of tubular return sections 47 that collectively define an outer tube 38 which surrounds the chamber assembly 20. In one embodiment, each U-tube assembly 36 may include a pair of upper oil separation tubes 40 in communication with a single lower water separation tube 42 through a respective tubular return section 47. The upper oil separation tubes 40 may be inclined downwardly from and in fluid flow communication with the upper chamber 32 of the chamber assembly 20, while the lower water separation tubes 42 are inclined downwardly from and in fluid flow communication with the lower chamber 34 of the chamber assembly 20. As such, the upper chamber 32 communicates with the lower chamber 34 through fluid pathways defined by the U-tube assembly 36 and outer tube 38. As viewed from above in FIG. 4, these various components define a wheel-shaped configuration with the chamber assembly 20 representing the hub, the U-tube assemblies 36 representing the spokes, and the tubular return sections 47 of the outer tube 38 collectively representing the rim of the wheel.

The embodiment of the centrifugal separation apparatus 10 shown in FIG. 4 may have eight separate U-tube assemblies 36A-H in communication with the outer tube 38 through a respective tubular return section 47A-H. However, in other embodiments, there may be less than eight or more than eight U-tube assemblies 36. In this embodiment, each U-tube assembly 36 includes a pair of upper oil separation tubes 40A and 40B that communicate with a single lower water separation tube 42.

Also projecting outwardly in a radial direction from the chamber assembly 20 are the oil outlet tubes 44 and water outlet tubes 46 that discharge oil 7 and water 9 to the inner and intermediate compartments 24 and 26, respectively. Each of the oil outlet tubes 44 communicates with the upper chamber 32 through a respective nipple 52, while each of the water outlet tubes 46 communicates directly with the lower chamber 34. In one embodiment, both the oil outlet tubes 44 and water outlet tubes 46 may be bent downwardly so that the oil outlet 68 (shown in phantom) defined at the free end of each oil outlet tube 44 and the water outlet 70 (shown in phantom) defined at the free end of each water outlet tube 46 communicate directly with the intermediate compartment 26 and inner compartment 24, respectively.

To collect the water 9, oil 7 and resultant debris, referred to as sluff 8 entrained in the effluent 6, the vessel 12 defines various compartments. As noted above, the vessel 12 defines an inner compartment 24 that surrounds the cartridge 22 for collecting separated water 9. In addition, the vessel 12 includes an intermediate compartment 26 adapted for collecting separated oil 7 and an outer compartment 28 adapted for collecting the sluff 8 that contains debris, sediment, and other by-product material produced by the operation of the centrifugal separation apparatus 10. The vessel 12 further includes an oil discharge outlet 126 in communication with the intermediate compartment 26 for permitting the collected oil 9 to be transported to a storage site (not shown) outside of vessel 12. Similarly, a water discharge outlet 128 is in communication with the inner chamber 24 for allowing collected water 7 to be transported to another storage site (not shown).

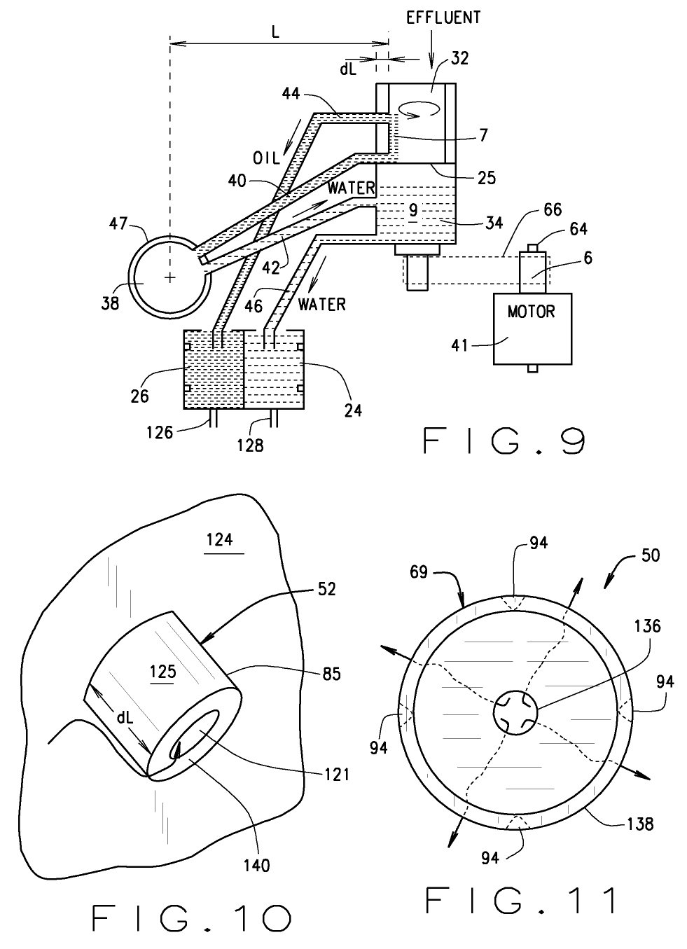

As shown in FIGS. 3 and 10, each of the plurality of oil outlet tubes 44 includes a nipple 52 at one end that projects inwardly a predetermined distance, dL, in a radial direction into the upper chamber 32 from interior wall 124. The nipple 52 includes a tubular body 85 that forms a tubular wall 125 and a cylindrical lip 140 defining an inlet 121 in communication with the oil outlet tube 44. The nipple 52 provides a means for receiving oil 7 that migrates from either the upper oil separation tubes 40A and 40B or along the interior wall 124 from the distribution cone 50 during the centrifugal separation process as shall be discussed in greater detail below.

In one embodiment, the oil and water outlet tubes 44 and 46 as well as the U-tube assemblies 36 and outer tube 38 may be structurally supported by a strain retaining plate 48. The strain retaining plate 48 prevents centripetal forces generated by the rotation of the main shaft 14 from applying excessive strain to the U-tube assemblies 36, especially the joints of the U-tube assemblies 36 that engage the chamber assembly 20 at one end and the outer tube 38 at the opposite end thereof. In addition, the strain retaining plate 48 may be secured directly to the oil and water outlet tubes 44 and 46 and indirectly to the outer tube 38 as discussed below.

Referring to FIG. 5, the strain retaining plate 48 includes a body 105 that defines a plurality of protruding portions 144 interposed between respective well portions 146 with a central aperture 160 formed in the center of the strain retaining plate 48. The central aperture 160 is sized and shaped to receive the main shaft 14 therein such that the main shaft 14 freely rotates within the central aperture 160. The body 105 defines an outer opening 162 adapted to engage and structurally support a respective oil outlet tube 44 and an inner opening 164 adapted to engage and structurally support a respective water outlet tube 46. In addition, each well portion 146 defines an opening 166 adapted to secure the strain retaining plate 148 to a respective tubular return section 47 of outer tube 38. As shown in FIGS. 2 and 5, the strain retaining plate 48 is secured to the outer tube 38 through a plurality of turnbuckle arrangements 65 that engage each well portion 146 of the strain retaining plate 48 to a respective retainer plate 142 secured to the outer tube 38. Each turnbuckle arrangement 65 includes a turnbuckle 118 having a proximal end 137 secured to the strain retaining plate 48 at a respective opening 166 through a bolt (not shown) inserted therein and the distal end 139 secured to the outer tube 38 through a respective retainer plate 142. In this way, the strain retaining plate 48 prevents the forces applied by the centripetal forces from applying excessive stress to the U-tube assemblies 36 as well as the oil and water outlet tubes 44 and 46.

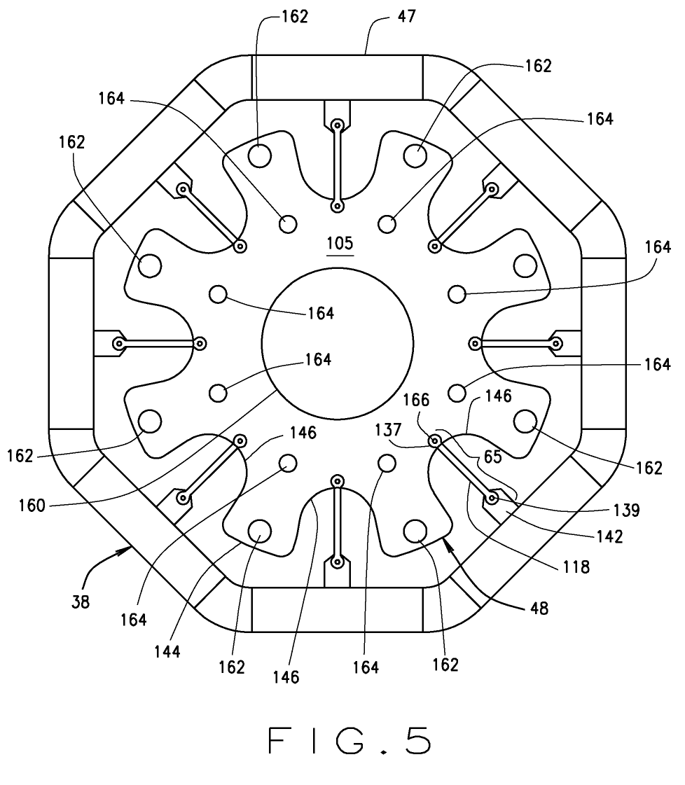

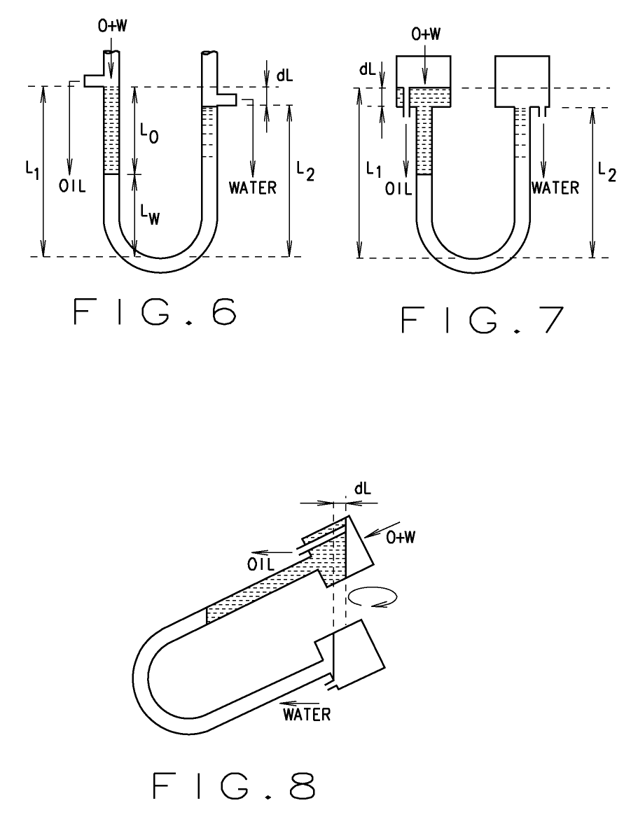

To understand the operation of the centrifugal separation apparatus 10 shown in FIGS. 1-5, certain hydrostatic and fluid dynamic principles need to be understood as illustrated in FIGS. 6-9. Referring to FIG. 6, there is illustrated two liquid columns of a U-tube in hydrostatic equilibrium. The length L1 of the left column is slightly greater than the length L2 of the right column. The difference between the length L1 and L2, i.e., L1-L2, may be referred to as dL. It is assumed that the left hand column contains water having a typical density of 1.0 and oil having a typical density range of between 0.75 to 0.85. The length of the oil column is L₀ and the length of the water is Lw. The right hand column (length L2) is filled with water. At hydrostatic equilibrium, the following equation applies:

L₀×Q₀×Lw×qw×Xg=L2×qw×g
Where
Q₀=density of oil 7 (typically 0.75 to 0.85)
Qw=density of water A(1.0)
G=acceleration due to gravity

### Accordingly,

Lw=L2×qw−L1×q₀/dq
Where
Dq=qw−q0
Lw=0, i.e., when L1 is all oil:

L2/L1=q₀/qw

This shows that the ratio of the lengths of the upper oil separation tubes 40 and the lower separation tube 42 determines the maximum ratio of liquid densities that can be separated by the centrifugal separation apparatus 10. For example, If L₁ is 16 inches and L₂ is 15 inches, then L₂ over L₁=0.9375, showing that with such tube lengths oil with a density of 0.9375 or less can be separated from water having a density of 1.0. Accordingly, if oil and water flow into the upper end of the left hand column, as illustrated in FIG. 6, so that the level of both the right and left hand columns increase, water will flow out of the right hand column and oil will flow out of the left hand column.

FIG. 7 illustrates the same hydrostatic balance illustrated in FIG. 6. The schematic of FIG. 7 simply illustrates a version in which an oil chamber is provided at the upper end of the left hand column and a water chamber provided at the upper end of the right hand column. However, it should be noted that an overflow tube provided with the water chamber opens directly at the bottom of the water chamber and an overflow tube for the oil chamber is extended slightly up into the oil chamber so that the level of oil in the oil chamber is slightly higher than the level of water in the water chamber. As shown, the difference in these heights is the same as the difference in the height of the liquid columns of FIG. 6, i.e., dL.

It should be noted that either one of the situations illustrated in FIGS. 6 and 7, the earth's acceleration of gravity “g”, or any other value for gravity, does not affect the hydrostatic principles set forth herein. The effectiveness of separation of one liquid dispersed into another liquid is determined by the difference of two opposing forces, weight and buoyancy, which is expressed by the variable “dqg”. The higher “g” at a given “dq”, the larger the separation force required. As such, the net force acting on one ml of water submerged in a light oil, i.e., kerosene, would be dq=0.25 gm/ml. Increased gravity from 1 g (the earth's acceleration of gravity) to approximately 1800 g's (artificial gravity which might be created by rapid rotation of a U-tube assembly 36 by the main shaft 14) results in an apparent change of weight from 0.25 gram force to 450 gram force. FIG. 8 illustrates the principle of increased enhanced gravity by rotation as might occur with an inclined U-tube assembly 36, such as shown in FIG. 8, rotating about a central axis.

Referring to FIG. 9, this same principle is illustrated in the schematic that corresponds to the embodiment of the centrifugal separation apparatus 10 shown in FIGS. 2 and 3. As the chamber assembly 20 is rotated, for example at 2,000 rpm, by the main shaft 14, effluent 6 containing a mixture of oil 7 and water 9 enters the rotating upper chamber 32. In one embodiment of the centrifugal separation apparatus 10 in which the separation plate 25 is six feet in diameter, gravity generated due to rotation of the main shaft 14 in the middle of the U-tube assembly 36 is about 2,000 grams. In one embodiment, if the upper and lower chambers 32 and 34 have respective diameters of 10 inches, the centrifugal gravity is about 450 grams. These numbers are sufficient to ensure effective separation of oil 7 and water 9. As this occurs, the effluent 6 containing oil 7 and water 9 flows down each pair of upper oil separation tubes 40 into the tubular return section 47, with any water 9 flowing into the lower water separation tube 42 and into the lower chamber 34. Any oil 7 in the effluent 6 will have a tendency to rise or flow upwardly through the upper end of the upper oil separation tubes 40 and accumulate in the area between the nipples 52 until the oil 7 migrates into the inlet 121 of the nipple 52 for transport through the oil outlet tube 44.

As noted above, when the effluent 6 flows into the distribution cone 50 the effluent 6 is radially distributed through lower part of the upper chamber 32. As effluent 6 is rotated inside the upper chamber 32 by rotation of the main shaft 14, the effluent 6 will begin to flow through each pair of upper oil separation tubes 40 of the U-tube assembly 36 and into the tubular return section 47. However, due to gravity and the enhanced gravitational effect from the centrifugal forces generated by the centrifugal separation apparatus 10, the water 9 in the tubular return section 47 flows into the lower water separation tubes 42 for collection in the lower chamber 34, while the oil 7 returning through the upper oil separation tubes 40. As water 9 flowing from the lower water separation tubes 42 accumulates in the lower chamber 34, the water 9 overflows into the water outlet tubes 46 and into the inner chamber 24.

In contrast, the oil 7 in the effluent 6 will separate from the water 9 and tend to rise and flow back through the pair of upper oil separation tubes 40 as illustrated by U-tube assembly 36A (FIG. 4) and begin to accumulate in the space between the nipples 52 in the upper chamber 32 until the accumulated oil 7 flows into the inlet 121 of each nipple 52 and into the oil outlet tubes 44. The oil 7 will then collects in the intermediate chamber 26.

Due to the centripetal forces generated by the centrifugal separation apparatus 10, there is a tendency for any sluff 8 in the effluent 6 to accumulate in the tubular return sections 47 of the outer tube 38. In one embodiment, the outer tube 38 may define apertures (not shown) sealed with plugs (not shown) that may be opened to allow water to be introduced into the outer tube 38 to flush out the sediment 8 into the outer chamber 28.

Referring back to FIG. 1, the microprocessor controller 37 is operatively associated with a vibration safety switch 35. The vibration safety switch 35 provides a means for detecting the degree of vibrations generated during the operation of the apparatus and prevents the catastrophic failure of the centrifugal separation apparatus 10 in situations when the operation of apparatus 10 causes excessive vibrations that exceed a predetermined value, such as when the effluent 6 is not evenly distributed in the U-tube assemblies 36 and/or the outer tube 38. In particular, the vibration safety switch 35 may include a sensor (not shown) that detects the degree of vibrations generated by rotation of main shaft 14. When the degree of vibrations exceeds a predetermined value, the vibration safety switch 35 will instruct the microprocessor 37 to terminate operation of motor 41 to cease immediate operation of the centrifugal separation apparatus 10. In another embodiment, the vibration safety switch 35 may be operable to directly terminate the operation of the centrifugal separation apparatus 10 when vibrations generated by operation of the apparatus 10 exceeds a predetermined value.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. An apparatus for separating oil and water from a stream of fluid whose components include oil and water comprising:
a hollow vessel having an inlet tube through which the stream of fluid may enter the vessel,
a rotatable chamber assembly centrally disposed in the vessel for rotation about a vertical axis with the rotatable chamber assembly including an upper chamber and a lower chamber, wherein the upper chamber is in fluid flow communication with the inlet tube to receive the stream of fluid and one or more nipples that extend a predetermined distance into the upper chamber,
one or more U-tube assemblies with each U-tube assembly having at least one upper tube and at least one lower tube, wherein the at least one upper tube and the at least one lower tube being in fluid flow communication with a connecting outer tube,
a strain retaining plate engaged to said outer tube and said chamber assembly for providing structural support to the one or more U-tube assemblies; and
a rotatable main shaft in operative engagement with the rotatable chamber assembly for rotating the chamber assembly about the vertical axis at a predetermined speed in which the stream of fluid entering the upper chamber is subjected to centripetal forces which in combination with gravitational forces cause oil and water in the stream of fluid to separate, wherein the water passes through the at least one upper tube, the connecting outer tube, and the at least one lower tube for collection in the lower chamber such that water may exit through a water outlet tube in communication with the lower chamber, wherein the oil flows through the at least one upper tube to the outer tube and back through the at least one upper tube for accumulation in the upper chamber such that the oil exits the upper chamber through the one or more nipples.

2. The apparatus of claim 1, wherein the strain retaining plate is engaged to the outer tube and the chamber assembly by a turnbuckle arrangement.

3. The apparatus of claim 2, wherein the strain retaining plate includes a body that defines a plurality of protruding portions interposed between respective well portions with a central aperture formed in the center of the body that is sized and shaped to receive the main shaft such that the main shaft freely rotates within the central aperture, wherein each well portion defines an outer aperture.

4. The apparatus of claim 3, wherein the body of the strain retaining plate defines a plurality of outer openings adapted to engage and structurally support a respective oil outlet tube, and a plurality of inner openings adapted to engage and structurally support a respective water outlet tube.

5. The apparatus of claim 3, wherein the turnbuckle arrangement includes a turnbuckle having a proximal end secured to the outer aperture of the strain retaining plate and a distal end secured to the retainer plate.

6. The apparatus of claim 5, wherein the proximal end defines an opening adapted to receive a securing member for securing the proximal end of the turnbuckle to the outer aperture of the strain retaining plate, and wherein the distal end defines an opening adapted to receive another securing member for securing the distal end of the turnbuckle to the retainer plate of the outer tube.

7. The apparatus of claim 1, wherein the at least one upper tube extends outwardly in a radial direction and inclined downwardly from the upper chamber and the at least one lower tube extends outwardly in a radial direction and inclined downwardly from the lower chamber.

8. The apparatus of claim 1, wherein the each of the one or more nipples is in communication with a respective oil outlet tube for the collection of oil.

9. An apparatus for separating oil and water from a stream of fluid whose components include oil and water comprising:
a hollow vessel having an inlet tube through which the stream of fluid may enter the vessel,
a rotatable chamber assembly centrally disposed in the vessel for rotation about a vertical axis with the chamber assembly defining an upper chamber in communication with the inlet tube for receiving the stream of fluid and a lower chamber for the storage of water separated from the stream of fluid,
one or more U-tube assemblies with each of the one or more U-tube assemblies having a proximal end that extends outwardly in a radial direction from the chamber assembly and a distal end that is engaged and in communication with an outer tube,
a main shaft operatively engaged to the rotatable chamber assembly for rotating the chamber assembly at a predetermined speed about the vertical axis in which the stream of fluid entering the chamber assembly is subjected to centripetal forces which in combination with gravitational forces cause oil and water in the stream of fluid to separate, and
a strain retaining plate engaged to the outer tube and the chamber assembly for providing structural support to the one or more U-tube assemblies.

10. The apparatus of claim 9, wherein the strain retaining plate is engaged to the outer tube and the chamber assembly by a turnbuckle arrangement.

11. The apparatus of claim 10, wherein the strain retaining plate includes a body that defines a plurality of protruding portions interposed between respective well portions with a central aperture formed in the center of the body that is sized and shaped to receive the main shaft such that the main shaft freely rotates within the central aperture, wherein each well portion defines an outer aperture.

12. The apparatus of claim 11, wherein the body of the strain retaining plate defines a plurality of outer openings adapted to engage and structurally support a respective oil outlet tube, and a plurality of inner openings adapted to engage and structurally support a respective water outlet tube.

13. The apparatus of claim 11, wherein the turnbuckle arrangement includes a turnbuckle having a proximal end secured to the outer aperture of the strain retaining plate and a distal end secured to the retainer plate.

14. The apparatus of claim 13, wherein the proximal end defines an opening adapted to receive a securing member for securing the proximal end of the turnbuckle to the outer aperture of the strain retaining plate, and wherein the distal end defines an opening adapted to receive another securing member for securing the distal end of the turnbuckle to the retainer plate of the outer tube.

15. The apparatus of claim 9, wherein the at least one upper tube extends outwardly in a radial direction and inclined downwardly from the upper chamber and the at least one lower tube extends outwardly in a radial direction and inclined downwardly from the lower chamber.

16. The apparatus of claim 9, wherein the each of the one or more nipples is in communication with a respective oil outlet tube for the collection of oil.

17. The apparatus of claim 9, wherein the main shaft is in operative engagement with a motor for rotating the main shaft at a predetermined speed.

18. An apparatus for separating oil and water from a stream of fluid whose components include oil and water comprising:
a hollow vessel having an inlet tube through which the stream of fluid may enter the vessel,
a rotatable chamber assembly centrally disposed in the vessel for rotation about a vertical axis with the chamber assembly defining an upper chamber in communication with the inlet tube for receiving the stream of fluid and a lower chamber for the storage of water separated from the stream of fluid,
one or more U-tube assemblies with each of the one or more U-tube assemblies having a proximal end that extends outwardly in a radial direction from the chamber assembly and a distal end that is engaged and in communication with an outer tube,
a main shaft operatively engaged to the rotatable chamber assembly for rotating the chamber assembly at a predetermined speed about the vertical axis in which the stream of fluid entering the chamber assembly is subjected to centripetal forces which in combination with gravitational forces cause oil and water in the stream of fluid to separate,
a motor in operative engagement with the main shaft for rotating the chamber assembly, the motor being in operative association with a microprocessor controller for controlling the operation of the motor, and
a means for detecting the degree of vibrations generated by the apparatus, the means for detecting the degree of vibrations generated by the apparatus being in operative association with the microprocessor controller.

19. The apparatus of claim 18, wherein the means for detecting the degree of vibration generated by the apparatus comprises a safety switch that terminates the operation of the motor when the degree of vibrations exceeds a predetermined value.

20. The apparatus of claim 18, wherein when the degree of vibrations generated by the apparatus exceeds a predetermined value the microprocessor controller terminates the operation of the apparatus.
